(19) United States
(12) Patent Application Publication
(10) Pub. No.: US 2022/0284563 A1
(43) Pub. Date: Sep. 8, 2022

(54) METHOD FOR DISCOVERING DEFECTS IN PRODUCTS BY DETECTING ABNORMALITIES IN IMAGES, ELECTRONIC DEVICE, AND STORAGE MEDIUM

(71) Applicant: HON HAI PRECISION INDUSTRY CO., LTD., New Taipei (TW)

(72) Inventors: CHIH-TE LU, New Taipei (TW); TZU-CHEN LIN, New Taipei (TW); CHIN-PIN KUO, New Taipei (TW)

(21) Appl. No.: 17/684,533

(22) Filed: Mar. 2, 2022

(30) Foreign Application Priority Data
Mar. 2, 2021 (CN) 202110231540.0

(51) Int. Cl. G06T 7/00; G06T 9/00; G06V 10/774

(52) U.S. Cl. CPC G06T 7/001; G06T 9/002; G06V 10/7747; G06T 2207/20081; G06T 2207/20084; G06T 2207/20076; G06T 2207/30108

(57) ABSTRACT

A method for discovering defects in products by detecting abnormalities in images, an electronic device, and a storage medium are provided. The method includes training an autoencoder model using images of flawless products, inputting such an image into the autoencoder model, and determining whether a reconstructed image can be generated based on the image. The image is determined to be showing abnormality in respond that no reconstructed image is generated. In respond that the reconstructed image is generated, the reconstructed image corresponding to the image to be detected is obtained, and the presence of abnormality in the reconstructed image is determined according to a defect judgment criterion. This method running in the electronic device improves efficiency and accuracy of abnormality detection.

### FIELD

The present application relates to a technical field of product detection, and more particularly to a method for discovering defects in products by detecting abnormalities in images, an electronic device and a storage medium.

### BACKGROUND

In an actual industrial production process, there will be unavoidable surface defects on some products. Surface abnormalities will not only adversely affect aesthetics of the product, but also affect a performance of the product in more serious cases. In order to realize a quality control of the product, appearance is very important in the actual industrial production process. Traditional manual detection methods are highly dependent on a subjective judgment of human inspectors, and also have disadvantages such as poor real-time performance and high labor cost. Therefore, there is room for improvement.

### BRIEF DESCRIPTION OF THE DRAWINGS

FIG. 1 is a flow chart diagram of a method for discovering defects in products by detecting abnormalities in images in an embodiment of the present application.

FIG. 2 is a structural diagram of a detection device in an embodiment of the present application.

FIG. 3 is a structural diagram of an electronic device housing the detection device in an embodiment of the present application.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below. Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

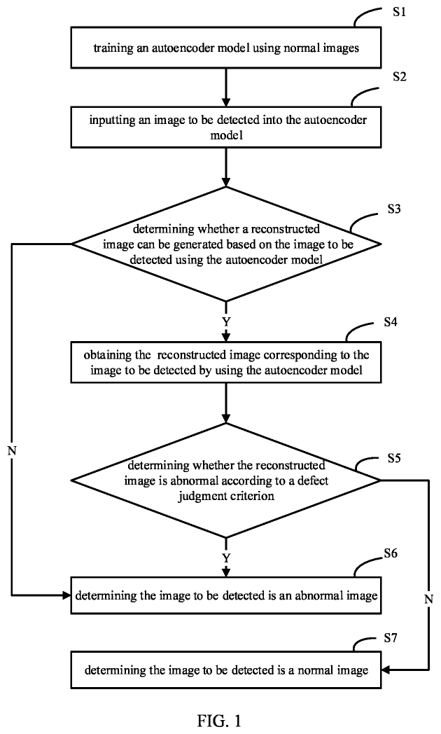

FIG. 1 is a flow chart diagram of a method for discovering defects in products by detecting, abnormalities in images in an, embodiment of the present application.

In one embodiment, the abnormality detection method can be applied to one or more electronic devices 3. The electronic device 3 includes hardware such as, but not limited to, a microprocessor and an Application Specific Integrated Circuit (ASIC), a Field-Programmable Gate Array (FPGA), a Digital Signal Processor (DSP), embedded devices, for example.

The electronic device 3 may be any electronic product that can interact with a user, such as a personal computer, a tablet computer, a smart phone, a personal digital assistant (Personal Digital Assistant, PDA), a game console, and an interactive network television. (Internet Protocol Television, IPTV), or smart wearable devices, for example.

The electronic device 3 may also include a network device and/or a user device. The network device includes, but s not limited to, a single network server, a server group composed of multiple network servers, or a cloud composed of a large number of hosts or network servers based on a cloud computing technology.

A network can include, but is not limited to, the Internet, a wide area network, a metropolitan area network, a local area network, and a virtual private network (VPN), for example.

In block S1, the electronic device 3 trains an autoencoder model using normal images.

In One Embodiment, a Preset Number of Normal Images are Collected, and an Implicit Low-dimensional vector h of each of the normal images is obtained. A T distribution is trained and learned by using the implicit low-dimensional vector h of each of the normal images.

The preset number of normal images represent images of a flawless product. Correspondingly, a plurality of images of defective products are captured and regarded as abnormal images. The normal images are captured by using an industrial camera. Since images generated by shooting products without defects under normal operation are normally flawless samples, a sufficient number (for example, 100,000) of normal images are obtained to be training samples through real-time shooting.

An image processing (for example, principal component analysis dimensionality reduction) is performed on each of the normal images, and an image vector X corresponding to each of the normal images is obtained. The vector X of each of the normal images is compressed by using an encoder, and the implicit low-dimensional vector h corresponding to each of the normal images is obtained.

The T distribution is acquired according to a machine learning process by training a variational autoencoder model using a distribution similarity of the implicit low-dimensional vector h. A density function expression of the T distribution s:

$$f ( t ) = \frac{Γ ( \frac{v + 1}{2} )}{\sqrt{v π} Γ ( \frac{v}{2} )} {( 1 + \frac{{t}^{2}}{v} )}^{\frac{- ( v + 1 )}{2}} ,$$

(formula (1)), where t is the implicit low-dimensional vector h, v is the degree of freedom and v=n−1, n is the preset number of normal images, and F represents a F function.

In block S2, the electronic device 3 inputs an image to be detected into the autoencoder model.

In one embodiment, the image to be detected may be an image obtained by capturing a product to be detected.

In block S3, the electronic device 3 determines whether a reconstructed image can be generated based on the image to be detected using the autoencoder model. In respond that no reconstructed image is generated based on the image to be detected, the procedure goes to block S6. In respond that the reconstructed image is generated based on the image to be detected, the procedure goes to block S4.

In one embodiment, a reconstruction probability p of the image to be detected is obtained based on a multi-layer neural network of the autoencoder model. In respond that the reconstruction probability p of the image to be detected is less than or equal to a reconstruction threshold δ, the electronic device 3 determines that the reconstructed image cannot be generated based on the image to be detected. In respond that the reconstruction probability p of the image to be detected is greater than the reconstruction threshold δ, the electronic device 3 determines that the reconstructed image can be generated based on the image to be detected.

In one embodiment, a selection manner of the reconstruction threshold δ depends on an expectation of a defect detection capability of the autoencoder model, and the selection manner of the reconstruction threshold δ is determined based on a balance between a recall rate and an accuracy rate of defect detection. In respond to the expectation of high accuracy, a maximum value of the reconstruction probability of the training samples is chosen as the reconstruction threshold δ. In respond to the expectation of high recall, a statistic based on the reconstruction probability of the training samples is recommended as the reconstruction threshold δ. For example, it is assumed that the reconstruction probability of the training samples obeys a Gaussian distribution, and a ninety percent (90%) quantile value of the Gaussian distribution may be used as the reconstruction threshold δ.

In block S4, in respond that the reconstructed image is generated based on the image to be detected, the electronic device 3 obtains the reconstructed image corresponding to the image to be detected by using the autoencoder model.

In block S5, the electronic device 3 determines whether the reconstructed image is abnormal according to a defect judgment criterion. In response that the reconstructed image is abnormal, the procedure goes to block S6. In response that the reconstructed image is normal, the procedure goes to block S7.

In one embodiment, an image mean square error (MSE) is obtained between the image to be detected and the reconstructed image. In respond that the MSE is less than or equal to an error threshold t, the image to be detected is determined to be a normal image. In respond that the MSE is greater than the error threshold τ, the image to be detected is determined to be an abnormal image.

In one embodiment, a calculation formula of the MSE is: MSE=(γ−\hat{γ})², (formula (2)), where γ is a pixel of the image to be detected, γ is a pixel of the reconstructed image of the image to be detected and corresponds to the pixel γ.

In one embodiment, a selection manner of the error threshold τ depends on an expectation of a defect detection capability of the autoencoder model, and the selection manner of the error threshold τ can be determined based on the balance between the recall rate and the accuracy rate of defect detection. A ninety percent quantile value of the T distribution may be used as the error threshold τ.

In one embodiment, the T distribution is biased towards long-tailed distributions. For example, if a greater defect of the image is detected, the image to be detected is closer to the tail end of the T distribution, a distance between the image to be detected and a position that is far from the tail end of the T distribution is larger, a similarity between the image to be detected and the reconstructed image is lower. Thus, the reconstruction probability becomes smaller and the image to be detected cannot be reconstructed.

In block S6, the electronic device 3 determines the image as being an image with abnormality.

In block S7, the electronic device 3 determines the image as being an image without abnormality.

In the above embodiments, according to a property of the T distribution, the electronic device 3 detects whether there is a defect on a product by using the autoencoder model, efficiency and accuracy of product detection can be improved.

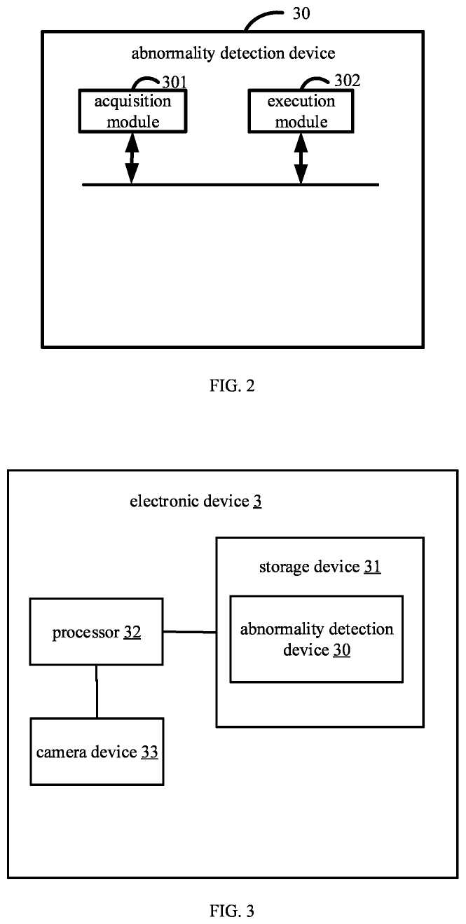

FIG. 2 is a structural diagram of a detection device in an embodiment of the present application.

As shown in FIG. 2, abnormality detection device 30 includes an acquisition module 301, and an execution module 302. The modules in the present application refer to one of a stored series of computer-readable instruction segments that can be executed by at least one processor and that are capable of performing preset functions. In some embodiments, the functions of each module will be described.

The acquisition module 301 obtains a plurality of normal images and an image to be detected captured by a camera device 33. The execution module 302 trains an autoencoder model using normal images, and the execution module 302 inputs an image to be detected into the autoencoder model. The execution module 302 determines whether a reconstructed image can be generated based on the image to be detected using the autoencoder model. In respond that no reconstructed image is generated based on the image to be detected, the execution module 302 determines the image to be detected is an abnormal image. In respond that the reconstructed image is generated based on the image to be detected, the execution module 302 obtains the reconstructed image corresponding to the image to be detected, and the execution module 302 determines whether the reconstructed image is abnormal according to a defect judgment criterion.

FIG. 3 is a structural diagram of an electronic device housing the detection device in an embodiment of the present application.

The electronic device 3 may include a storage device 31, at least one processor 32, and a camera device 33. Computer-readable instructions are stored in the storage device 31 and executable by the at least one processor 32.

Those skilled in the art will understand that FIG. 3 is only an example of the electronic device 3 and does not constitute a limitation on the electronic device 3. Another electronic device 3 may include more or fewer components than shown in the figures or may combine some components or have different components. For example, the electronic device 3 may further include an input/output device, a network access device, a bus, and the like.

The at least one processor 32 can be a central processing unit (CPU), or can be other general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 32 can be a microprocessor or any conventional processor. The processor 32 is a control center of the electronic device 3 and connects various parts of the entire electronic device 3 by using various interfaces and lines.

The processor 32 executes the computer-readable instructions to implement the method for discovering defects in products by detecting abnormalities in images in the above embodiments, such as in block S1-S7 shown in FIG. 1. Alternatively, the processor 32 executes the computer-readable instructions to implement the functions of the modules/units in the foregoing device embodiments, such as the modules 301-302 in FIG. 2.

For example, the computer-readable instructions can be divided into one or more modules/units, and the one or more modules/units are stored in the storage device 31 and executed by the at least one processor 32. The one or more modules/units can be a series of computer-readable instruction segments capable of performing specific functions, and the instruction segments are used to describe execution processes of the computer-readable instructions in the electronic device 3. For example, the computer-readable instruction can be divided into the acquisition module 301 and the execution module 302 as shown in FIG. 2.

The storage device 31 stores the computer-readable instructions and/or modules/units. The processor 32 may run or execute the computer-readable instructions and/or modules/units stored in the storage device 31 and may call up data stored in the storage device 31 to implement various functions of the electronic device 3. The storage device 31 mainly includes a storage program area and a storage data area. The storage program area may store an operating system, and an application program required for at least one function (such as a sound playback function, an image playback function, for example), for example. The storage data area may store data (such as audio data, phone book data, for example) created during the use of the electronic device 3. In addition, the storage device 31 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

The storage device 31 may be an external memory and/or an internal memory of the electronic device 3. The storage device 31 may be a memory in a physical form, such as a memory stick, or a Trans-flash Card (TF card), for example.

When the modules/units integrated into the electronic device 3 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

With reference to FIG. 1, the storage device 31 in the electronic device 3 stores a plurality of instructions to implement an abnormality detection method, and the processor 32 can execute the multiple instructions to: train an autoencoder model using normal images; input an image to be detected into the autoencoder model, and determine whether a reconstructed image can be generated based on the image to be detected using the autoencoder model; in respond that no reconstructed image is generated based on the image to be detected, determine the image to be detected is an abnormal image; or in respond that the reconstructed image is generated based on the image to be detected, obtain the reconstructed image corresponding to the image to be detected; and determine whether the reconstructed image is abnormal according to a defect judgment criterion.

The computer-readable instructions are executed by the processor 32 to realize the functions of each module/unit in the above-mentioned device embodiments, which will not be repeated here.

In the several embodiments provided in the preset application, the disclosed electronic device and method can be implemented in other ways. For example, the embodiments of the devices described above are merely illustrative. For example, a division of the modules is based on logical function only, and there can be other manners of division in actual implementation.

In addition, each functional module in each embodiment of the present disclosure can be integrated into one processing module, or can be physically present separately in each unit or two or more modules can be integrated into one module. The above modules can be implemented in a form of hardware or in a form of a software functional unit.

Therefore, the present embodiments are considered as illustrative and not restrictive, and the scope of the present disclosure is defined by the appended claims. All changes and variations in the meaning and scope of equivalent elements are included in the present disclosure. Any reference sign in the claims should not be construed as limiting the claim.

Moreover, the word “comprising” does not exclude other units nor does the singular exclude the plural. A plurality of units or devices stated in the system claims may also be implemented by one unit or device through software or hardware. Words such as “first” and “second” are used to indicate names, not any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. An abnormality detection method, the method comprising:
training an autoencoder model using normal images;
inputting an image to be detected into the autoencoder model, and determining whether a reconstructed image can be generated based on the image to be detected using the autoencoder model;
in respond that no reconstructed image is generated based on the image to be detected, determining the image to be detected is an abnormal image; or
in respond that the reconstructed image is generated based on the image to be detected, obtaining the reconstructed image corresponding to the image to be detected; and
determining whether the reconstructed image is abnormal according to a defect judgment criterion.

2. The abnormality detection method of claim 1, wherein, training the autoencoder model using normal images comprises:
collecting a preset number of normal images;
obtaining an implicit low-dimensional vector h of each of the preset number of normal images in the preset number of normal images;
training and learning a T distribution by using the implicit low-dimensional vector h of each of the preset number of normal images.

3. The abnormality detection method of claim 2, wherein obtaining, the implicit low-dimensional vector h of each of the preset number of normal images comprises:
performing an image processing on each of the preset number of normal images, and obtaining an image vector X corresponding to each of the preset number of normal images;
compressing the vector X of each of the preset number of no, mal images, and obtaining the implicit low-dimensional vector h corresponding to each of the preset number of normal images.

4. The abnormality detection method of claim 2, wherein training and learning a T distribution by using the implicit low-dimensional vector h of each of the preset number of normal images comprises:
acquiring the T distribution according to machine learning process by training a variational autoencoder model using a distribution similarity of the implicit low-dimensional vector h.

5. The abnormality detection method of claim 2, wherein a density function expression of the T distribution is:
$$f ( t ) = \frac{Γ ( \frac{v + 1}{2} )}{\sqrt{v π} Γ ( \frac{v}{2} )} {( 1 + \frac{{t}^{2}}{v} )}^{\frac{- ( v + 1 )}{2}} ,$$
t is the implicit low-dimensional vector h:
v is the degree of freedom and v=n−1, n is the preset number of normal images; and Γ is a Γ function.

6. The abnormality detection method of claim 1, wherein determining whether a reconstructed image can be generated based on the image to be detected using the autoencoder model comprises:
obtaining a reconstruction probability p of the image to be detected based on a multi-layer neural network of the autoencoder model;
in respond that the reconstruction probability p of the image to be detected is less than or equal to a reconstruction threshold δ, determining that the reconstructed image cannot be generated based on the image to be detected; or
in respond that the reconstruction probability p of the image to be detected is greater than the reconstruction threshold δ, determining that the reconstructed image can be generated based on the image to be detected.

7. The abnormality detection method of claim 1, wherein the defect judgment criterion comprises:
obtaining an image mean square error (MSE) between the image to be detected and the reconstructed image;
in respond that the MSE is less than or equal to an error threshold r, determining that the image to be detected is a normal image; or
in respond that the MSE is greater than the error threshold r, determining that the image to be detected is an abnormal image.

8. The abnormality detection method of claim 7, wherein a calculation formula of the MSE is:
MSE=(γ−\hat{γ})², γ is a pixel of the image to be detected, \hat{γ} is a pixel of the reconstructed image of the image to be detected and corresponds to the pixel γ.

9. An electronic device comprising:
a processor; and
a storage device storing a plurality of instructions, which when executed by the processor, cause the processor to:
train an autoencoder model using normal images;
input an image to be detected into the autoencoder model, and determine whether a reconstructed image can be generated based on the image to be detected using the autoencoder model;
in respond that no reconstructed image is generated based on the image to be detected, determine the image to be detected is an abnormal image; or
in respond that the reconstructed image is generated based on the image to be detected, obtain the reconstructed image corresponding to the image to be detected; and
determine whether the reconstructed image is abnormal according to a defect judgment criterion.

10. The electronic device of claim 9, wherein the processor is further caused to:
collect a preset number of normal images;
obtain an implicit low-dimensional vector h of each of the preset number of normal images in the preset number of normal images;
train and learn a T distribution by using the implicit low-dimensional vector h of each of the preset number of normal images.

11. The electronic device of claim 10, wherein the processor is further caused to:
perform an image processing on each of the preset number of normal images, and obtain an image vector X corresponding to each of the preset number of normal images;
compress the vector X of each of the preset number of normal images, and obtain the implicit low-dimensional vector h corresponding to each of the preset number of normal images.

12. The electronic device of claim 10, wherein the processor is further caused to:
acquire the T distribution according to machine learning process by training a variational autoencoder model using a distribution similarity of the implicit low-dimensional vector h.

13. The electronic device of claim 10, wherein a density function expression of the T distribution is:
$$f ( t ) = \frac{Γ ( \frac{v + 1}{2} )}{\sqrt{v π} Γ ( \frac{v}{2} )} {( 1 + \frac{{t}^{2}}{v} )}^{\frac{- ( v + 1 )}{2}} ,$$
t is the implicit low-dimensional vector h;
v is the degree of freedom and v=n−1, n is the preset number of normal images; and Γ is a Γ function.

14. The electronic device of claim 9, wherein the processor is further caused to:
obtain a reconstruction probability p of the image to be detected based on a multi-layer neural network of the autoencoder model;
in respond that the reconstruction probability p of the image to be detected is less than or equal to a reconstruction threshold δ, determine that the reconstructed image cannot be generated based on the image to be detected; or
in respond that the reconstruction probability p of the image to be detected is greater than the reconstruction threshold δ, determine that the reconstructed image can be generated based on the image to be detected.

15. A non-transitory storage medium having stored thereon at least one computer-readable instructions, which when executed by a processor of an electronic device, causes the processor to perform a method for determining a growth height of a plant, the method comprising:
training an autoencoder model using normal images;
inputting an image to be detected into the autoencoder model, and determining whether a reconstructed image can be generated based on the image to be detected using the autoencoder model;
in respond that no reconstructed image is generated based on the image to be detected, determining the image to be detected is an abnormal image; or
in respond that the reconstructed image is generated based on the image to be detected, obtaining the reconstructed image corresponding to the image to be detected; and
determining whether the reconstructed image is abnormal according to a defect judgment criterion.

16. The non-transitory storage medium of claim 15, wherein training the autoencoder model using normal images comprises:
collecting a preset number of normal images;
obtaining an implicit low-dimensional vector h of each of the preset number of normal images in the preset number of normal images;
training and learning a T distribution by using the implicit low-dimensional vector h of each of the preset number of normal images.

17. The non-transitory storage medium of claim 16, wherein obtaining the implicit low-dimensional vector h of each of the preset number of normal images comprises:
performing an image processing on each of the preset number of normal images, and obtaining an image vector X corresponding to each of the preset number of normal images;
compressing the vector X of each of the preset number of normal images, and obtaining the implicit low-dimensional vector h corresponding to each of the preset number of normal images.

18. The non-transitory storage medium of claim 16, wherein training and learning a T distribution by using the implicit low-dimensional vector h of each of the preset number of normal images comprises:
acquiring the T distribution according to machine learning process by training a variational autoencoder model using a distribution similarity of the implicit low-dimensional vector h.

19. The non-transitory storage medium of claim 16, wherein a density function expression of the T distribution is:
$$f ( t ) = \frac{Γ ( \frac{v + 1}{2} )}{\sqrt{v π} Γ ( \frac{v}{2} )} {( 1 + \frac{{t}^{2}}{v} )}^{\frac{- ( v + 1 )}{2}} ,$$
t is the implicit low-dimensional vector h;
v is the degree of freedom and v=n−1, n is the preset number of normal images; and Γ is a Γ function.

20. The non-transitory storage medium of claim 15, wherein determining whether a reconstructed image can be generated based on the image to be detected using the autoencoder model comprises:
obtaining a reconstruction probability p of the image to be detected based on a multi-layer neural network of the autoencoder model;
in respond that the reconstruction probability p of the image to be detected is less than or equal to a reconstruction threshold δ, determining that the reconstructed image cannot be generated based on the image to be detected; or
in respond that the reconstruction probability p of the image to be detected is greater than the reconstruction threshold δ, determining that the reconstructed image can be generated based on the image to be detected.
